(19) United States
(12) Patent Application Publication
(10) Pub. No.: US 2022/0344832 A1
(43) Pub. Date: Oct. 27, 2022

(54) ANTENNA DEVICE

(71) Applicant: AGC Inc., Tokyo (JP)

(72) Inventors: Toshiki SAYAMA, Tokyo (JP); Takeshi MOTEGI, Tokyo (JP); Akira KUMAGAI, Tokyo (JP); Yasuo MORIMOTO, Tokyo (JP); Osamu KAGAYA, Tokyo (JP); Keisuke ARAI, Tokyo (JP)

(73) Assignee: AGC Inc., Tokyo (JP)

(21) Appl. No.: 17/811,919

(22) Filed: Jul. 12, 2022

Related U.S. Application Data
(63) Continuation of application No. PCT/JP2021/003379, filed on Jan. 29, 2021.

(30) Foreign Application Priority Data
Feb. 3, 2020 (JP) 2020-016420

(51) Int. Cl. H01Q 21/06; H01Q 19/10; H01Q 13/10

(52) U.S. Cl. CPC H01Q 21/064; H01Q 19/10; H01Q 13/10

(57) ABSTRACT

An antenna device includes a flexible substrate, an antenna element provided on a front surface or a rear surface of the flexible substrate, a feeding line provided on the front surface or the rear surface of the flexible substrate to feed power to the antenna element, a dielectric in a plate shape stacked on a rear side of the flexible substrate, the dielectric having flexibility and being bendable, and a reflector plate provided on a rear side of the dielectric.

### CROSS-REFERENCE TO RELATED APPLICATION

The present application is a continuation application filed under 35 U.S.C. 111 (a) claiming benefit under 35 U.S.C. 120 and 365 (c) of PCT International Application No. PCT/JP2021/003379 filed on Jan. 29, 2021 and designating the U.S., which claims priority to Japanese Patent Application No. 2020-016420 filed on Feb. 3, 2020. The entire contents of the foregoing applications are incorporated herein by reference.

### BACKGROUND OF THE INVENTION

### 1. Field of the Invention

The present disclosure relates to an antenna device.

### 2. Description of the Related Art

In recent years, there is an ongoing trend of expansion of services using high-speed and large-capacity wireless communication systems communicating in microwave and millimeter wave frequency bands, such as a trend of transition from 4G LTE to 5G (sub6). As an antenna used in such a frequency band, a patch antenna using a rigid substrate that is generally referred to as a CCL is known.

The antenna device of Patent Literature 1 can emit beams in multiple directions with a simpler structure as compared with the case where a flexible substrate having different thicknesses depending on the areas is used and a rigid substrate such as an LTCC substrate is connected to the flexible substrate.

### CITATION LIST

### Patent Literature

PTL 1: Japanese Laid-Open Patent Publication No. 2019-4241

### SUMMARY OF THE INVENTION

### Technical Problem

According to tests conducted by the inventors of the present invention, it has been found that, in an antenna device such as a patch antenna used in a frequency band lower than 6 GHz that is referred to as “Sub6” (for example, 3.7 GHz band or 4.5 GHz band), in order to ensure a wide bandwidth in a predetermined frequency band, it is preferable that the substrate constituting the patch antenna has a sufficient thickness, for example, in the case of a glass substrate, the thickness is preferably 6 mm or more.

However, with the conventional technique, as the thickness of the glass substrate or the resin substrate increases, it becomes difficult to bend the antenna device, and therefore, it becomes difficult to install the antenna device on a curved surface (for example, an outer circumferential surface of a cylindrical object).

The present disclosure has been made in view of the above, and it is an object of the present disclosure to provide an antenna device that is installable along a curved surface, can achieve a wide bandwidth in a predetermined frequency band, and can emit strong electromagnetic waves in a single direction by reflecting the radiation of electromagnetic waves in the rear surface direction.

### Solution to Problem

In order to solve the above-described problem and achieve the object, an antenna device according to the present disclosure includes a flexible substrate, an antenna element provided on a front surface or a rear surface of the flexible substrate, a feeding line provided on the front surface or the rear surface of the flexible substrate to feed power to the antenna element, a dielectric in a plate shape stacked on a rear side of the flexible substrate, the dielectric having flexibility and being bendable, and a reflector plate provided on a rear side of the dielectric.

### Advantageous Effects of Invention

According to the antenna device of the present disclosure, an antenna device that is installable along a curved surface, can achieve a wide bandwidth in a predetermined frequency band, and can emit strong electromagnetic waves in a single direction by reflecting the radiation of electromagnetic waves in the rear surface direction can be provided.

### BRIEF DESCRIPTION OF THE DRAWINGS

FIG. 1 is a plan view illustrating an antenna device according to the embodiment.

FIG. 2 is a cross-sectional view taken along line A-A of the antenna device according to the embodiment.

FIG. 3 is a drawing illustrating an example of installation of the antenna device according to the embodiment to an outer circumferential surface of a pillar.

FIG. 4 illustrates a directivity of the antenna device according to the embodiment.

FIGS. 5A and 5B illustrate a directivity of the antenna device according to the embodiment.

FIG. 6 is a graph illustrating antenna characteristics (S11) of the antenna device according to the embodiment.

FIG. 7 is a plan view illustrating an antenna device according to a first modified embodiment.

FIGS. 8A and 8B are drawings illustrating a directivity of the antenna device according to the first modified embodiment.

FIG. 9 is a graph illustrating antenna characteristics (S11, S21) of the antenna device according to the first modified embodiment.

FIG. 10 is a plan view illustrating an antenna device according to a second modified embodiment.

FIG. 11 is a drawing illustrating an example of connection of feeding lines of the antenna device according to the second modified embodiment.

FIG. 12 is a drawing illustrating a cross-sectional configuration of an antenna device according to a second modified embodiment.

FIG. 13 is a plan view illustrating an antenna device according to a third modified embodiment.

FIG. 14 is a plan view illustrating an antenna device according to a fourth modified embodiment.

FIG. 15 is a plan view illustrating an antenna device according to a fifth modified embodiment.

FIG. 16 is a plan view illustrating an antenna device according to a sixth modified embodiment.

FIG. 17 is a diagram illustrating an example of bandwidths based on combinations of the thickness and the dielectric constant of dielectric in the antenna device according to the embodiment.

FIG. 18 is a diagram illustrating an example of bandwidths based on combinations of the thickness and the dielectric constant of dielectric in the antenna device according to the embodiment.

FIG. 19 is an external perspective view illustrating a first use state of the antenna device according to the embodiment.

FIG. 20 is a graph illustrating antenna characteristics (VSWR value) in a first use state of the antenna device according to the embodiment.

FIG. 21 is an external perspective view illustrating a second use state of the antenna device according to the embodiment.

FIG. 22 is a graph illustrating antenna characteristics (VSWR value) in the second use state of the antenna device according to the embodiment.

FIG. 23 is an external perspective view illustrating a third use state of the antenna device according to the embodiment.

FIG. 24 is a graph illustrating antenna characteristics (VSWR value) in the third use state of the antenna device according to the embodiment.

FIG. 25 is an external perspective view illustrating a flat state of an antenna device according to a seventh modified embodiment.

FIGS. 26A and 26B are drawings illustrating a directivity of the antenna device according to the seventh modified embodiment (a flat state illustrated in FIG. 25).

FIG. 27 is an external perspective view illustrating a bent state of the antenna device according to the seventh modified embodiment.

FIGS. 28A and 28B are drawings illustrating a directivity of the antenna device according to the seventh modified embodiment (a bent state illustrated in FIG. 27).

### DETAILED DESCRIPTION OF THE PREFERRED EMBODIMENTS

Embodiments according to the present disclosure are described below with reference to the drawings.

(Configuration of Antenna Device 10)

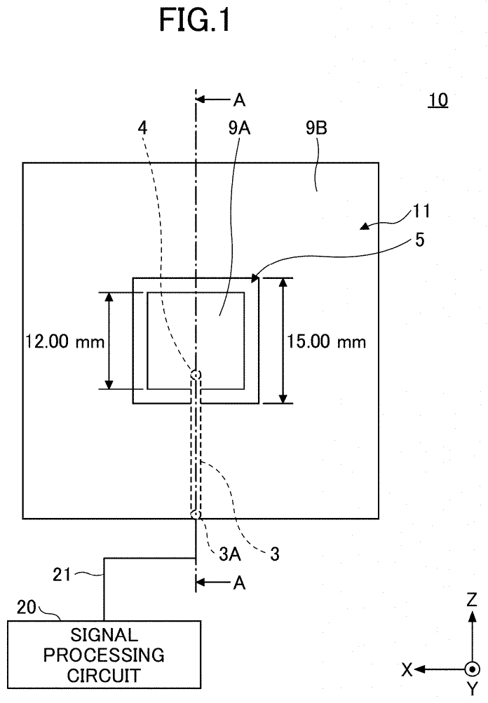

FIG. 1 is a plan view illustrating an antenna device 10 according to the embodiment. As illustrated in FIG. 1, the antenna device 10 has a square shape in a plan view as seen from a front surface side (the positive side of the Y axis). As illustrated in FIG. 1, a conductor layer 11 in a thin film shape made of a conductive material is formed over the entire surface of the antenna device 10.

In the present embodiment, the antenna device 10 is provided on a vertical surface (for example, an outer circumferential surface of a vertically installed pillar). Therefore, in the present embodiment, the direction of a vertical edge of the antenna device 10 (Z axis direction) is defined as a vertical direction and an up-and-down direction, and the direction of a horizontal edge of the antenna device 10 (X axis direction) is defined as a horizontal direction and a left-and-right direction. Furthermore, in the present embodiment, a direction normal to the surface of the antenna device 10 (i.e., a direction orthogonal to the XZ plane) is defined as a Y axis direction. In the present embodiment, the positive side of the Y axis of the antenna device 10 is referred to as a front side, and the negative side of the Y axis of the antenna device 10 is referred to as a rear side.

In the example illustrated in FIG. 1, an antenna element 5 in a slit shape that has a belt shape and a square shape is provided in a central portion of the conductor layer 11 of the antenna device 10. The antenna element 5 is what is termed as a slot loop antenna. The antenna element 5 is formed by cutting out a portion of the conductor layer 11. The antenna element 5 is used for transmitting and receiving electromagnetic waves in a predetermined frequency band. For example, the antenna element 5 is used for transmitting and receiving electromagnetic waves in a frequency band lower than 6 GHz (for example, 3.7 GHz band or 4.5 GHz band) referred to as “Sub 6” used in 5G (fifth generation mobile communication system), but applicable frequencies are not limited thereto. The antenna element 5 has a square shape with its vertical edge being in the vertical direction and its horizontal edge being in the horizontal direction in a plan view as seen from the front side (the positive side of the Y axis). In the conductor layer 11, a portion on the inner side of the antenna element 5 functions as a ground plate 9A, and a portion on the outer side of the antenna element 5 functions as a ground plate 9B.

As illustrated in FIG. 1, in the antenna device 10, a feeding line 3, in a thin film shape and in a belt shape, that is made of a conductive material is provided on the rear side (the negative side of the Y axis) of the conductor layer 11. The feeding line 3 linearly extends upward (i.e., in the Z axis positive direction) from the central portion, in the horizontal direction (X axis direction), of the lower edge portion of the antenna device 10. The upper end portion of the feeding line 3 is connected to the vicinity of the lower edge portion of the ground plate 9A through a via 4. However, the feeding line 3 may be open at a position that is away by a distance of about ¼ λg (where λg is the electrical length of one wavelength in view of the effect of the dielectric constant of the flexible substrate 12) from the lower edge portion of the ground plate 9A, so that the feeding line 3 is electrically connected to the ground plate 9A in a non-contact manner by electromagnetic coupling. A signal processing circuit 20 is connected to a connection point 3A provided at the lower end portion of the feeding line 3 via a connection line 21. The signal processing circuit 20 includes, for example, an AMP (Amplifier), a switch, a mixer, a DAC (Digital to Analog Converter), an ADC (Analog to Digital Converter), and the like.

By receiving a signal from the signal processing circuit 20 to the ground plate 9A via the connection line 21 and the feeding line 3, the antenna device 10 can radiate electromagnetic waves (vertically polarized waves) for carrying the signal in a predetermined frequency band from the antenna element 5. The signal processing circuit 20 may be provided outside of the antenna device 10 or may be provided in the antenna device 10 (for example, on a surface of the flexible substrate 12).

In the example illustrated in FIG. 1, the length of one edge of the square shape formed by the antenna element 5 is “15.00 mm”, which is ¼ wavelength of the predetermined frequency, and the length of one edge of the square shape formed by the ground plate 9A is “12.00 mm”. That is, the width of the belt of the antenna element 5 is “1.50 mm”.

(Cross-Sectional Configuration of Antenna Device 10)

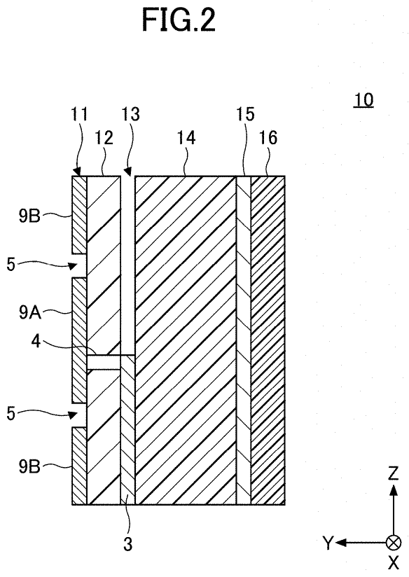

FIG. 2 is a cross-sectional view taken along line A-A of the antenna device 10 according to the embodiment. As illustrated in FIG. 2, the antenna device 10 includes a conductor layer 11, a flexible substrate 12, a wiring layer 13, a dielectric 14, a reflector plate 15, and a flexible substrate 16, which are arranged from the front surface side (the positive side of the Y axis). The antenna device 10 has a multilayer structure formed by stacking multiple constituent members. The antenna device 10 is not limited to the cross-sectional configuration of FIG. 2, and, for example, the wiring layer 13 may be formed on the front surface of the flexible substrate 12 (the surface on the positive side of the Y axis), and the conductor layer 11 may be formed on the rear surface of the flexible substrate 12 (the surface on the negative side of the Y axis). Also, for example, the reflector plate 15 may be formed on the rear surface of the flexible substrate 16 (the surface on the negative side of the Y axis). Also, the reflector plate 15 may be provided at least on the rear side (the negative side of the Y axis) with respect to the dielectric 14, and for example, the reflector plate 15 may be formed on the rear surface of the dielectric 14 (the surface on the negative side of the Y axis). In this case, the antenna device 10 does not have to have the flexible substrate 16.

The conductor layer 11 is formed on the front surface of the flexible substrate 12 (the surface on the positive side of the Y axis). The conductor layer 11 is in a thin film shape and has conductivity. For example, the conductor layer 11 is made of a conductive material such as copper. For example, the thickness of the conductor layer 11 is 1 nm to 32 μm. As illustrated in FIG. 1, in the conductor layer 11, the antenna element 5 in the belt shape is formed in a square shape. The antenna element 5 is formed by partially cutting out a portion of the conductor layer 11. Thus, in the conductor layer 11, the ground plate 9A in the square shape is formed in an area surrounded by the antenna element 5. In the example illustrated in FIG. 1, the conductor layer 11 is formed over the entire surface of the flexible substrate 12. That is, in the example illustrated in FIG. 1, the conductor layer 11 is in a square shape similar to the flexible substrate 12 in a plan view.

The flexible substrate 12 is a member that is made of resin and that is in a thin film shape having flexibility. For example, the flexible substrate 12 is formed using a resin material having flexibility such as fluorine, COP (cyclo olefin polymer), PET (polyethylene terephthalate), PEN (polyethylene naphthalate), polyimide, Peek (polyether ether ketone), LCP (liquid crystal polymer), or other composite materials. For example, the thickness of the flexible substrate 16 is 1 μm to 300 μm. The flexible substrate 12 is provided with the via 4 penetrating the flexible substrate 12 in the up-and-down direction.

The wiring layer 13 is formed on the rear surface of the flexible substrate 12 (the surface on the negative side of the Y axis). The wiring layer 13 is provided with the feeding line 3 in a thin film shape and in a belt shape that linearly extends in the up-and-down direction (Z axis direction). The upper end portion of the feeding line 3 is connected to the lower edge portion of the ground plate 9A to be orthogonal thereto through the via 4 provided in the flexible substrate 12. Thus, the antenna element 5 can radiate vertically polarized waves.

The dielectric 14 is a bendable plate-shaped member having flexibility that is provided on the rear side of the flexible substrate 12. For example, the dielectric 14 is made of an elastic dielectric material (for example, sponge, rubber, urethane, and the like). The dielectric 14 has such a thickness as to achieve a predetermined bandwidth in a predetermined frequency band. For example, a suitable thickness of the dielectric 14 may be determined by simulation or the like. For example, the dielectric 14 is bonded to the rear surface (the surface on the negative side of the Y axis) of the flexible substrate 12 by any bonding means (for example, adhesives, double-sided tapes, and the like). In the present embodiment, the shape and size of the dielectric 14 are the same as the shape and size of the flexible substrate 12, but the present embodiment is not limited thereto. The dielectric 14 may have a larger size than the flexible substrate 12 and may have a shape different from the flexible substrate 12 (that is, a shape different from a square shape).

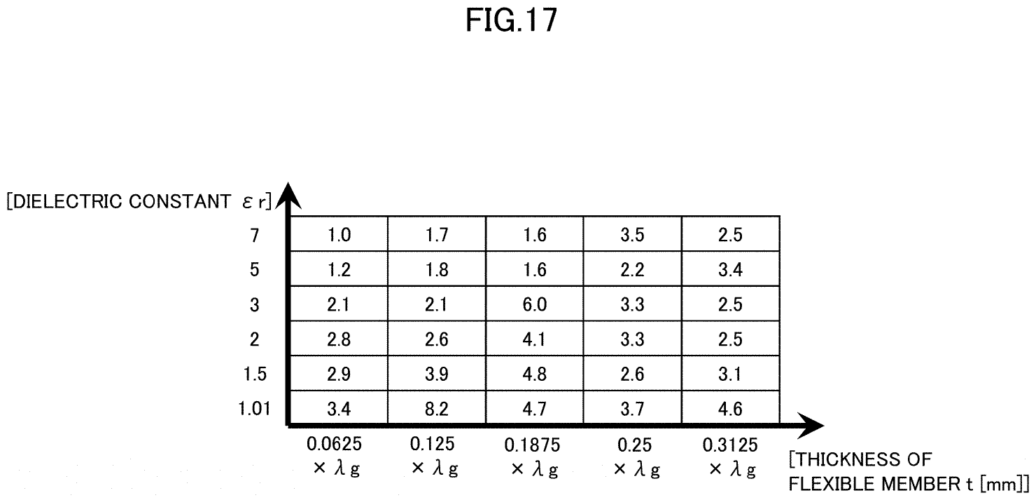

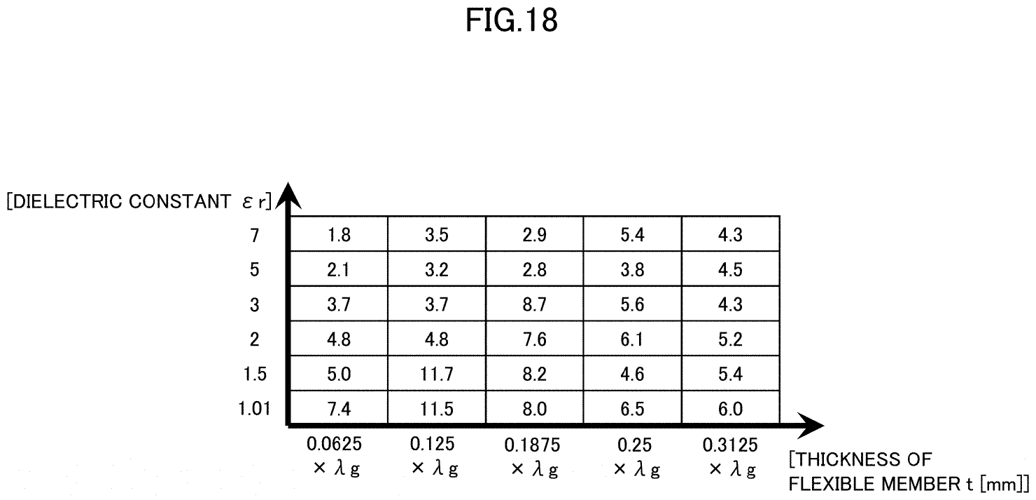

An example of a suitable thickness of the dielectric 14 is hereinafter described with reference to FIGS. 17 and 18. FIGS. 17 and 18 are diagrams illustrating examples of bandwidths based on combinations of the thicknesses and dielectric constants of dielectric 14 in the antenna device 10 according to the embodiment (the antenna device 10 having the configurations illustrated in FIGS. 1 and 2). FIG. 17 illustrates an example of a bandwidth in which the VSWR is less than 1.5. FIG. 18 illustrates an example of a bandwidth in which the VSWR is less than 2.0.

As illustrated in FIGS. 17 and 18, the bandwidth of the antenna system 10 may be determined based on a combination of the thickness and the dielectric constant of the dielectric 14. Therefore, in order to achieve a suitable bandwidth (that is, a sufficiently wide bandwidth) with the antenna device 10, it is preferable to derive the lists illustrated in FIGS. 17 and 18 in advance by simulation or the like, and to determine the thickness and dielectric constant of the dielectric 14 that is actually used based on the list. The dielectric constant of the dielectric 14 can be changed, for example, by adjusting and changing the material.

For example, the bandwidth in which the VSWR is less than 1.5 is preferably 2% or more, more preferably 3% or more, and still more preferably 5% or more. In this case, as can be understood from the list in FIG. 17, it is sufficient to adopt a combination of the thickness and the dielectric constant of the dielectric 14 that can achieve a bandwidth of 2% or more, 3% or more, or 5% or more.

For example, the bandwidth for which the VSWR is less than 2.0 is preferably 3.5% or more, more preferably 7% or more, and still more preferably 10.5% or more. In this case, as can be understood from the list in FIG. 18, it is sufficient to adopt a combination of the thickness and the dielectric constant of the dielectric 14 that can achieve a bandwidth of 3.5% or more, 7% or more, or 10.5% or more.

It should be noted that λg used for the thickness of the dielectric 14 denotes the electrical length of one wavelength in the dielectric, and can be calculated by the equation {λg=λ0/√εr}. In this case, λ0 denotes the electrical length of one wavelength in air.

Further, illustrated in FIGS. 17 and 18, the antenna device 10 according to the embodiment is configured to be bendable and to have the dielectric 14, and thus, a sufficiently wide bandwidth can be achieved overall as compared with conventional bendable antenna devices. Furthermore, it has been confirmed that even when the antenna device 10 according to the embodiment is used in a bent state, a change in the bandwidth hardly occurs as compared with the case where it is used in a flat state.

The reflector plate 15 is formed over the entire front surface (the surface on the positive side of the Y axis) of the flexible substrate 16. The reflector plate 15 is in a thin film shape and has conductivity. For example, the reflector plate 15 is made of a conductive material such as copper. For example, the thickness of the reflector plate 15 is 1 nm to 32 μm. The reflector plate 15 is provided to reflect radiation of electromagnetic waves from the antenna element 5 to the rear side (the negative side of the Y axis) of the antenna device 10.

The flexible substrate 16 is provided so as to be stacked on the rear surface (the surface on the negative side of the Y axis) of the dielectric 14. Similar to the flexible substrate 12, the flexible substrate 16 is a member that is made of resin and that is in a thin film shape having flexibility. For example, the flexible substrate 16 is formed by using substantially the same material as the flexible substrate 12. However, the flexible substrate 16 may be different from the flexible substrate 12 in at least one of material and thickness. For example, the flexible substrate 16 is bonded to the rear surface (the surface on the negative side of the Y axis) of the dielectric 14 by any bonding means (for example, adhesives, double-sided tapes, and the like) with the reflector plate 15 being formed on the front surface (the surface on the positive side of the Y axis).

(Example of Installation of Antenna Device 10)

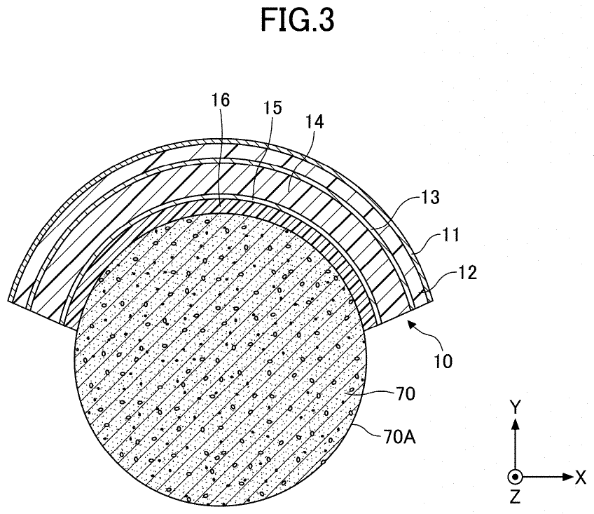

FIG. 3 is a drawing illustrating an example of installation of the antenna device 10 according to the embodiment to an outer circumferential surface 70A of a pillar 70. As illustrated in FIG. 3, the antenna device 10 can be bent as a whole because the dielectric 14 and the flexible substrates 12, 16 are bendable. Therefore, illustrated in FIG. 3, the antenna device 10 is installable on the outer circumferential surface 70A while it is bent along the outer circumferential surface 70A of the pillar 70. For example, the antenna device 10 is installable on the outer circumferential surface 70A of the pillar 70, such as a traffic signal, a street lamp, a telephone pole, and the like, but is not limited thereto. For example, the antenna device 10 can be fixed to the outer circumferential surface 70A of the pillar 70 by any bonding means (for example, adhesives, double-sided tapes, and the like).

(Antenna Characteristics of Antenna Device 10)

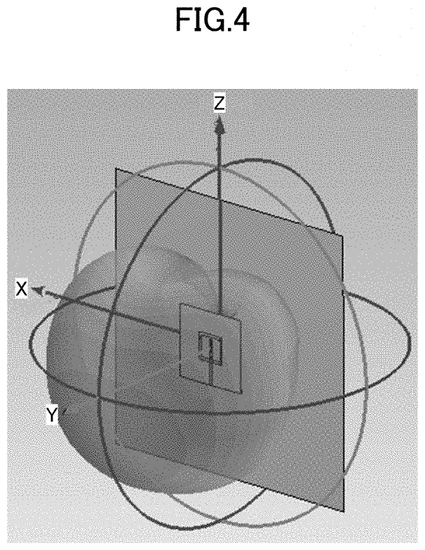

Next, the antenna characteristics of the antenna device 10 according to the embodiment obtained through the tests conducted by the inventors of the present invention are explained with reference to FIGS. 4 to 6.

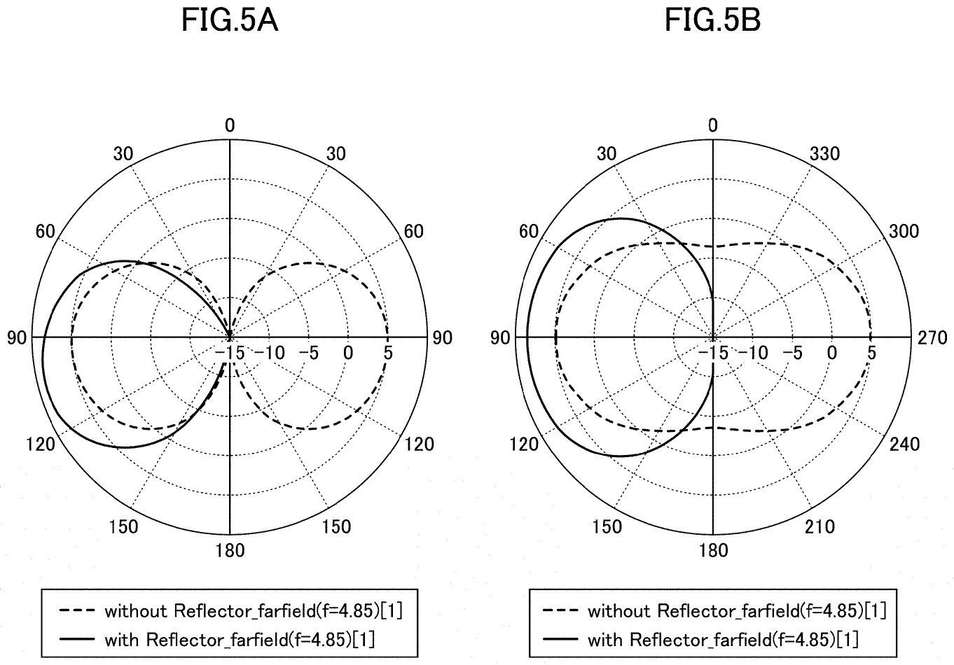

FIG. 4 and FIGS. 5A and 5B are drawings illustrating directivities of the antenna device 10 according to the embodiment. FIG. 5A illustrates the directivity of the antenna device 10 in the ZY plane in 4.85 GHz band. FIG. 5B illustrates the directivity of the antenna device 10 in the XY plane in the 4.85 GHz band.

In FIGS. 5A and 5B, a solid line represents the directivity when the antenna device 10 is provided with the reflector plate 15, and a broken line represents the directivity when the antenna device 10 is not provided with the reflector plate 15.

As illustrated in FIGS. 4 and 5, the antenna device 10 according to the embodiment can radiate, with the antenna element 5, vertically polarized waves with a sufficiently high gain in the front surface direction of the antenna device 10 (the positive side of the Y axis).

Furthermore, as illustrated in FIGS. 5A and 5B, the antenna device 10 according to the embodiment can reflect, with the reflector plate 15, vertically polarized waves emitted in the rear surface direction of the antenna device 10 (the negative side of the Y axis) toward the front surface direction of the antenna device 10 (the positive side of the Y axis). Therefore, the antenna device 10 according to the embodiment can enhance the strength of the vertically polarized electromagnetic waves toward the front surface direction of the antenna device 10 (the positive side of the Y axis).

Furthermore, the antenna device 10 according to the embodiment can reduce the effect of the outer circumferential surface 70A, which is an object to which the antenna device 10 is to be installed, on the electromagnetic waves radiated from the antenna element 5 by providing the reflector plate 15. That is, the antenna device 10 according to the embodiment is installable on various outer circumferential surfaces 70A irrespective of the material of the outer circumferential surface 70A.

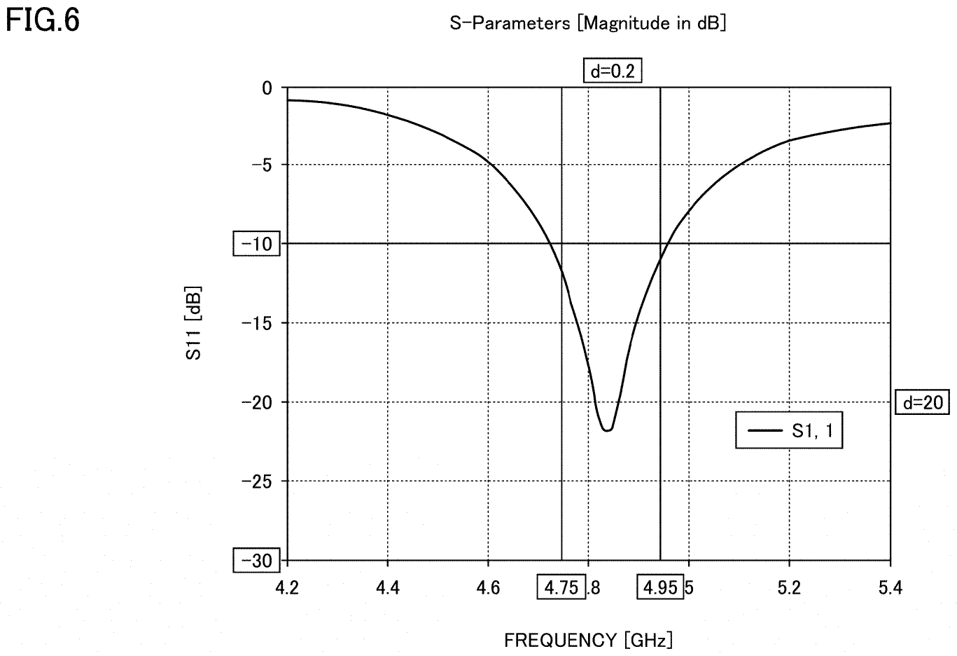

FIG. 6 is a graph illustrating antenna characteristics (S11) of the antenna device 10 according to the embodiment. As illustrated in FIG. 6, the antenna device 10 according to the embodiment can reduce the reflection coefficient (S11) to “−10 dB” or less (corresponding to VSWR<2) in a predetermined frequency band (4.75 to 4.95 GHz) by providing the dielectric 14 having a certain thickness (15 mm in this test) and by providing the reflector plate 15. That is, the antenna device 10 according to the embodiment can achieve a wide bandwidth (200 MHz) in the predetermined frequency band (4.75 to 4.95 GHz).

(Antenna Characteristics of First Use State)

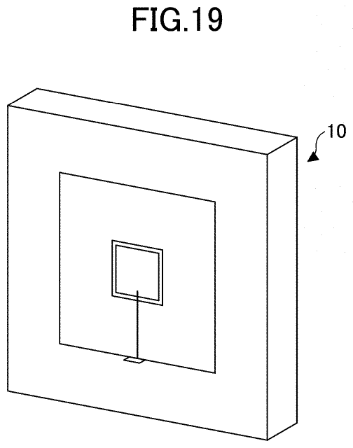

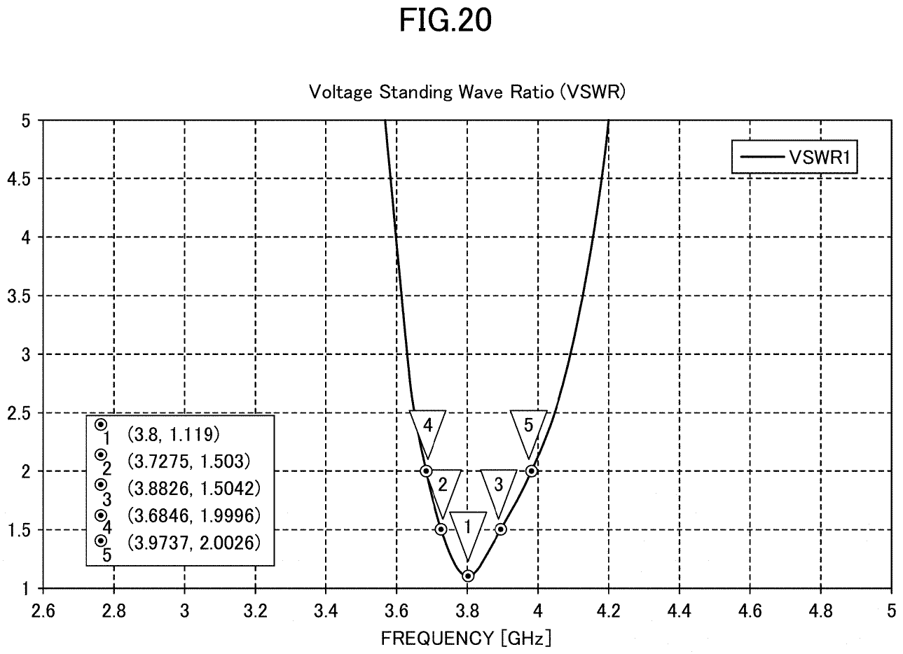

FIG. 19 is an external perspective view illustrating a first use state of the antenna device 10 according to the embodiment. FIG. 20 is a graph illustrating antenna characteristics (VSWR value) in the first use state of the antenna device 10 according to the embodiment. As illustrated in FIG. 19, the antenna device 10 according to the embodiment can be used in a flat state as the first use state. This first use state is effective when the antenna device 10 is installed on a flat installation target surface. As illustrated in FIG. 20, it has been confirmed that the antenna device 10 according to the embodiment can achieve a wide bandwidth having a center frequency of 3.8 GHz in the first use state, and in particular, can achieve a sufficiently wide bandwidth of “4.1%” as a bandwidth having a VSWR of less than 1.5.

(Antenna Characteristics in Second Use State)

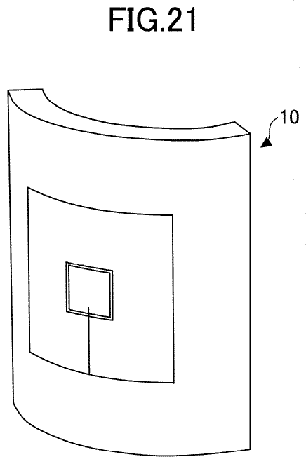

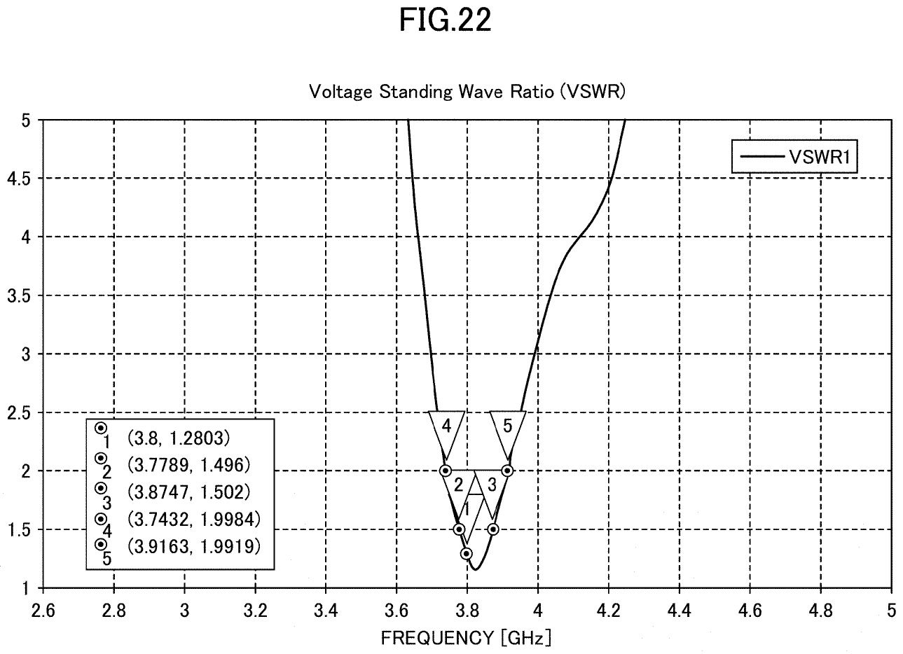

FIG. 21 is an external perspective view illustrating a second use state of the antenna device 10 according to the embodiment. FIG. 22 is a graph illustrating antenna characteristics (VSWR value) in the second use state of the antenna device 10 according to the embodiment. As illustrated in FIG. 21, the antenna device 10 according to the embodiment can be used in a bent state that is bent along the horizontal direction as the second use state. This second use state is effective when the antenna device 10 is installed on an installation target surface that is bent along the horizontal direction (for example, the outer circumferential surface of a cylindrical pillar or the like). As illustrated in FIG. 22, it has been confirmed that the antenna device 10 according to the embodiment can achieve a wide bandwidth having a center frequency of 3.8 GHz in the second use state, and in particular, can achieve a sufficiently wide bandwidth of “2.5%” as a bandwidth having a VSWR of less than 1.5.

(Antenna Characteristics in Third Use State)

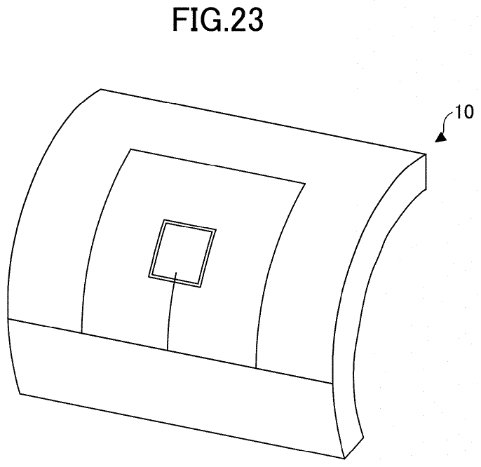

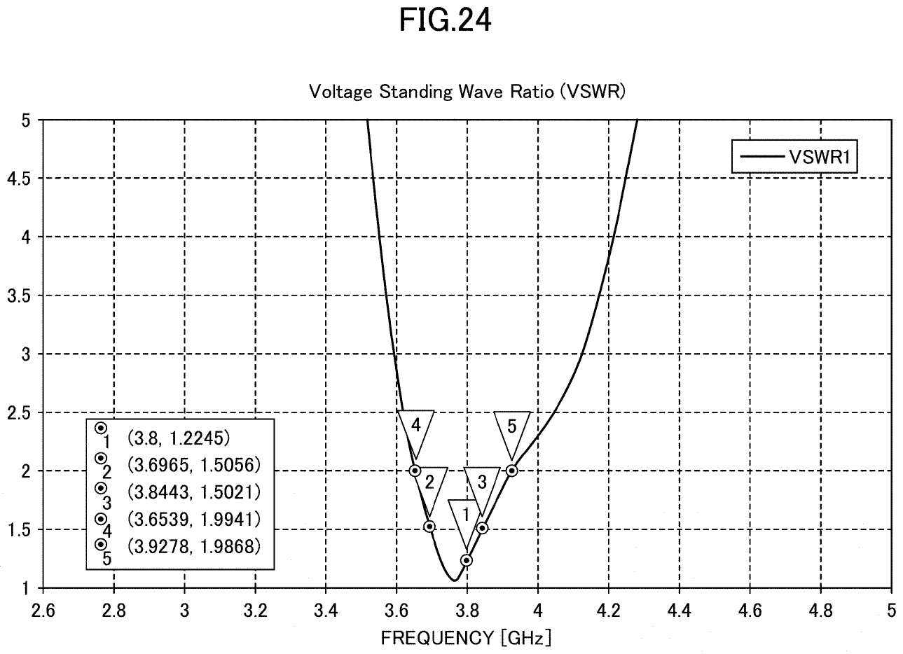

FIG. 23 is an external perspective view illustrating a third use state of the antenna device 10 according to the embodiment. FIG. 24 is a graph illustrating antenna characteristics (VSWR value) in the third use state of the antenna device 10 according to the embodiment. As illustrated in FIG. 23, the antenna device 10 according to the embodiment can be used in a bent state that is bent along the vertical direction as the third use state. This third state of use is effective when the antenna device 10 is installed on an installation target surface that is bent along the vertical direction. As illustrated in FIG. 24, it has been confirmed that the antenna device 10 according to the embodiment can achieve a wide bandwidth having a center frequency of 3.8 GHz in the third use state, and in particular, can achieve a sufficiently wide bandwidth of “3.9%” as a bandwidth having a VSWR of less than 1.5.

In the examples illustrated in FIGS. 19 to 24, the same antenna device 10 having the configurations illustrated in FIGS. 1 and 2 is used, and the thickness of the dielectric 14 is “0.1875*λg” and the dielectric constant of the dielectric 14 is “2”.

Therefore, it has been confirmed that when the antenna device 10 according to the embodiment has the configuration illustrated in FIGS. 1 and 2, a sufficient wide bandwidth can be achieved when it is used in either the flat state or the bent state.

(First Modified Embodiment of Antenna Device 10)

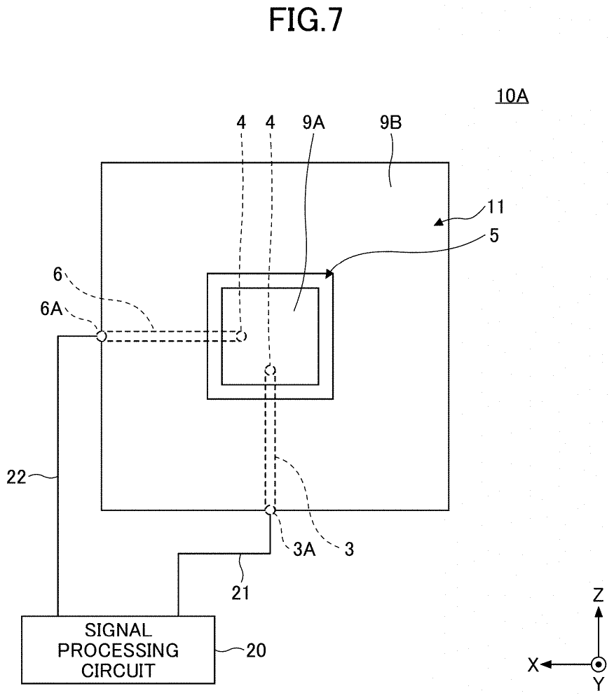

Next, a first modified embodiment of the antenna device 10 according to the embodiment is described. FIG. 7 is a plan view illustrating an antenna device 10A according to a first modified embodiment. The antenna device 10A illustrated in FIG. 7 is different from the antenna device 10 illustrated in FIG. 1 in that the wiring layer 13 on the rear side (the negative side of the Y axis) of the conductor layer 11 is further provided with a feeding line 6 in a thin film shape and in belt shape that is made of a conductive material. The feeding line 6 linearly extends from the central portion of the left edge portion of the antenna device 10 toward the right (the negative side of the X axis). The right end portion of the feeding line 6 is connected to the vicinity of the left edge portion of the ground plate 9A through a via 4. A signal processing circuit 20 is connected to a connection point 6A provided at the left end portion of the feeding line 6 via a connection line 22.

The antenna device 10A according to the first modified embodiment can radiate vertically polarized waves and horizontally polarized waves from the antenna element 5. Specifically, when a signal is fed from the signal processing circuit 20 to the ground plate 9A via the connection line 21 and the feeding line 3 (a first feeding line), the antenna device 10A according to the first modified embodiment can radiate vertically polarized waves of the predetermined frequency band from the antenna element 5. Furthermore, when a signal is fed from the signal processing circuit 20 to the ground plate 9A via the connection line 22 and the feeding line 6 (a second feeding line), the antenna device 10A according to the first modified embodiment can radiate horizontally polarized waves of the predetermined frequency band from the antenna element 5.

(Antenna Characteristics of Antenna Device 10A)

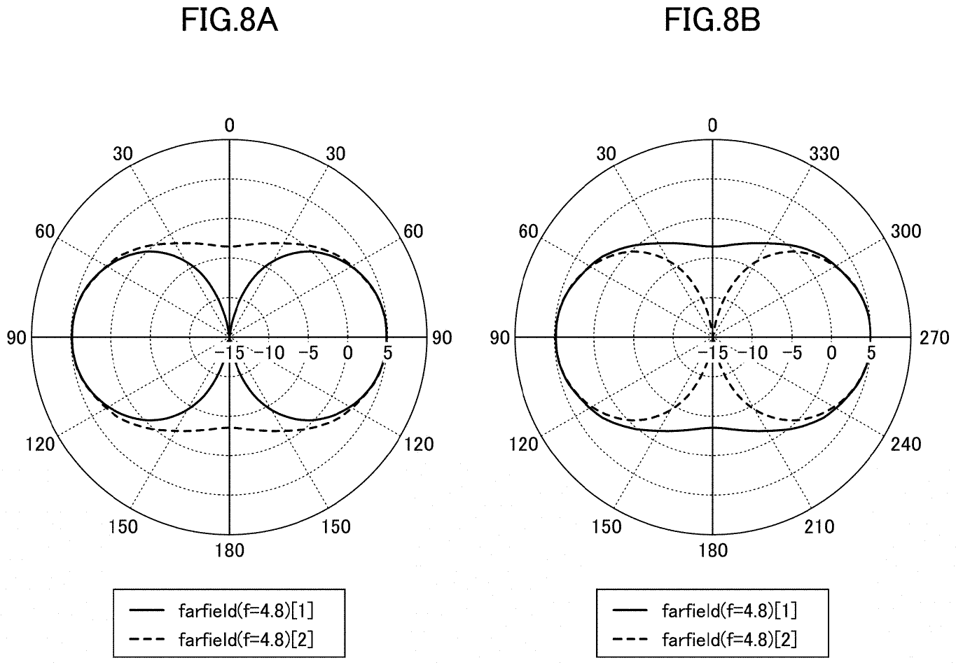

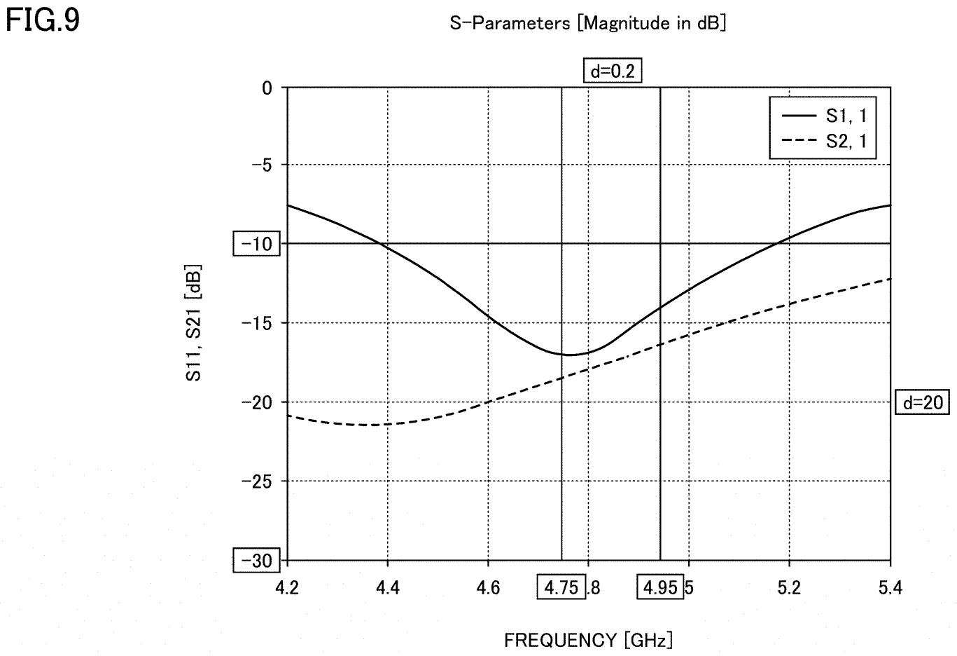

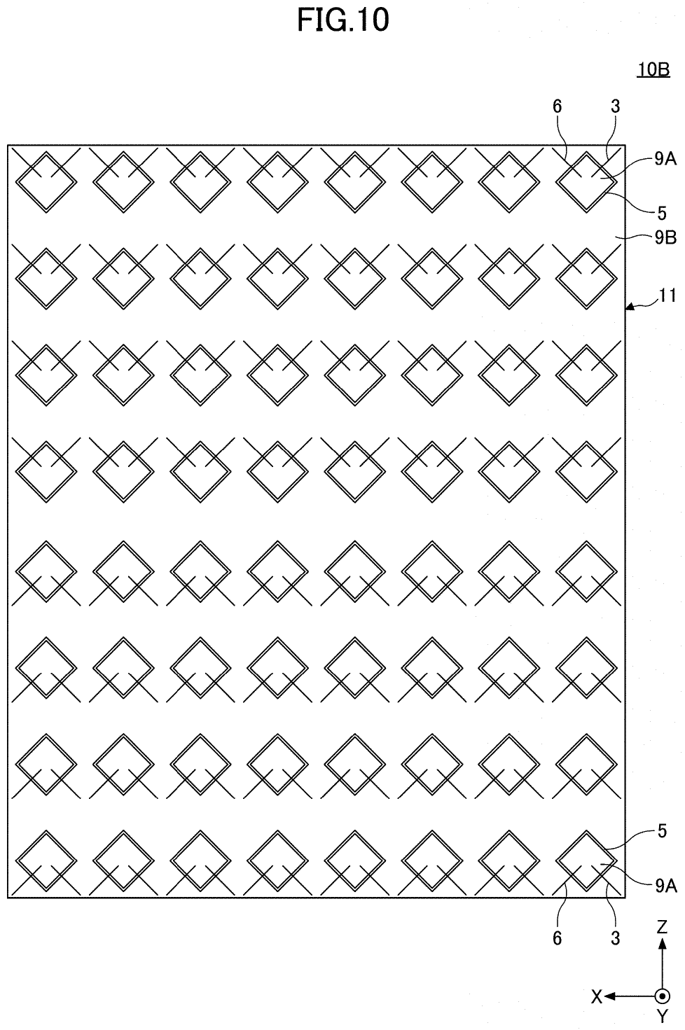

Next, the antenna characteristics of the antenna device 10A according to the first modified embodiment obtained through the tests conducted by the inventors of the present invention are explained with reference to FIGS. 8 and 9.

FIGS. 8A and 8B are drawings illustrating a directivity of the antenna device 10A according to the first modified embodiment. FIG. 8A illustrates the directivity of the antenna device 10A according to the first modified embodiment in the ZY plane in 4.85 GHz band. FIG. 8B illustrates the directivity of the antenna device 10A according to the first modified embodiment in the XY plane in the 4.85 GHz band.

In FIG. 8A, a solid line represents the antenna characteristics in the YZ plane of vertically polarized waves radiated from the antenna element 5, and a broken line represents the antenna characteristics in the YX plane of vertically polarized waves radiated from the antenna element 5. In FIG. 8B, a solid line represents the antenna characteristics in the YZ plane of horizontally polarized waves radiated from the antenna element 5, and a broken line represents the antenna characteristics of the YX plane of horizontally polarized waves radiated from the antenna element 5.

As illustrated in FIGS. 8A and 8B, the antenna device 10A according to the first modified embodiment can radiate, with the antenna element 5, each of vertically polarized waves and horizontally polarized waves with a sufficiently high gain in the front surface direction of the antenna device 10A (the positive side of the Y axis).

FIGS. 8A and 8B illustrate the antenna characteristics when the antenna device 10A according to the first modified embodiment is not provided with the reflector plate 15. When the antenna device 10A according to the first modified embodiment is provided with the reflector plate 15 similarly to the antenna device 10 illustrated in FIG. 1, the electromagnetic waves in the front surface direction (the positive side of the Y axis) can be strengthened by reflecting the radiation of the vertically polarized waves and the horizontally polarized waves emitted in the rear surface direction of the antenna device 10A (the negative side of the Y axis).

FIG. 9 is a graph illustrating the antenna characteristics (S11, S21) of the antenna device 10A according to the first modified embodiment. In FIG. 9, a solid line represents the reflection coefficient (S11) of each of the vertically polarized waves and horizontally polarized waves by the antenna device 10A, and a broken line represents the transmission coefficient (S21) of each of the vertically polarized waves and horizontally polarized waves by the antenna device 10A.

As illustrated in FIG. 9, the antenna device 10A according to the first modified embodiment can reduce the reflection coefficient (S11) of each of the vertically polarized waves and horizontally polarized waves to “−10 dB” or less (corresponding to VSWR<2) in the predetermined frequency band (4.75 to 4.95 GHz) by providing the antenna device 10A according to the first modified embodiment with the dielectric 14 having a certain thickness (15 mm in this test) and with the reflector plate 15.

Furthermore, as illustrated in FIG. 9, the antenna device 10A according to the first modified embodiment can reduce the transmission coefficient (S21) of each of the vertically polarized waves and horizontally polarized waves to “−15 dB” or less in the predetermined frequency band (4.75 to 4.95 GHz)

That is, the antenna device 10A according to the first modified embodiment can achieve a wide bandwidth (200 MHz) in the predetermined frequency band (4.75 to 4.95 GHz).

(Second Modified Embodiment of Antenna Device 10)

Next, a second modified embodiment of the antenna device 10 according to the embodiment is explained. FIG. 10 is a plan view illustrating an antenna device 10B according to the second modified embodiment.

The antenna device 10B illustrated in FIG. 10 includes a plurality of antenna elements 5 arranged in a matrix form arranged in the horizontal direction (X axis direction) and the vertical direction (Z axis direction) in the conductor layer 11. In the example illustrated in FIG. 10, the antenna device 10B has eight antenna elements 5 arranged side by side in the horizontal direction (X axis direction) and in the vertical direction (Z axis direction). That is, the antenna device 10B has 64 antenna elements 5 arranged in the 8 by 8 matrix form in the conductor layer 11.

Furthermore, in the antenna device 10B illustrated in FIG. 10, two feeding lines 3, 6 of which the directions are 90 degrees different from each other are provided for each of the 64 antenna elements 5, similarly to the antenna device 10A illustrated in FIG. 7.

However, illustrated in FIG. 10, in the antenna device 10B, the multiple antenna elements 5 and the feeding lines 3, 6 in the lower four rows are rotated counterclockwise by 45 degrees as compared with the antenna elements 5 and the feeding lines 3, 6 of the antenna device 10A illustrated in FIG. 7. Thus, in the lower four rows of the antenna device 10B, the feeding line 3 is connected at a right angle to the lower right oblique edge of the ground plate 9A in the antenna element 5, and the feeding line 6 is connected at a right angle to the lower left oblique edge of the ground plate 9A.

Furthermore, as illustrated in FIG. 10, in the antenna device 10B, the multiple antenna elements 5 and the feeding lines 3, 6 in the upper four rows are inverted upside down as compared with the antenna elements 5 and the feeding lines 3, 6 in the lower four rows. Thus, in the upper four rows of the antenna device 10B, the feeding line 3 is connected at a right angle to the upper right oblique edge of the ground plate 9A, and the feeding line 6 is connected at a right angle to the upper left oblique edge of the ground plate 9A.

When power is fed to either the feeding line 3 or the feeding line 6, the antenna device 10B configured as described above can radiate two kinds of electromagnetic waves having polarization directions 90 degrees different from each other from each of the multiple antenna elements 5.

(Example of Connection of Feeding Lines 3, 6)

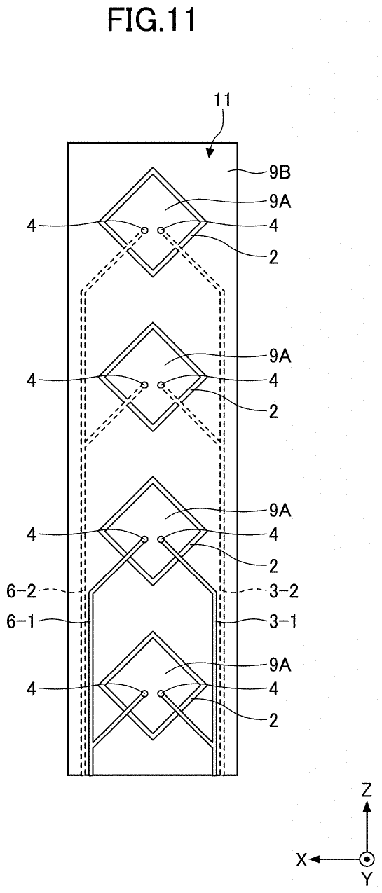

FIG. 11 is a drawing illustrating an example of connection of the feeding lines 3, 6 in the antenna device 10B according to the second modified embodiment. FIG. 11 illustrates lower four antenna elements 5 arranged in the vertical direction in the antenna device 10B. In the example illustrated in FIG. 11, the antenna device 10B includes two feeding lines 3-1, 3-2 and two feeding lines 6-1, 6-2 for the four antenna elements 5. The feeding lines 3-1, 6-1 are connected to the lower two antenna elements 5. The feeding lines 3-2, 6-2 are connected to the upper two antenna elements 5. Each of the feeding lines 3-1, 3-2, 6-1, and 6-2 is connected to the signal processing circuit 20.

When power is fed from the signal processing circuit 20 to either the feeding line 3-1 or the feeding line 6-1, the antenna device 10B configured as described above can radiate two kinds of electromagnetic waves having polarization directions 90 degrees different from each other from the lower two antenna elements 5 of the four antenna elements 5.

When power is fed from the signal processing circuit 20 to either the feeding line 3-2 or the feeding line 6-2, the antenna device 10B can radiate two kinds of electromagnetic waves having polarization directions 90 degrees different from each other from the upper two antenna elements 5 of the four antenna elements 5.

When the antenna device 10B is disposed on the outer circumferential surface 70A of the pillar 70 in a cylindrical shape, the antenna device 10B radiates two kinds of electromagnetic waves having polarization directions 90 degrees different from each other in each of multiple directions (up to 8 directions) around the pillar 70. In this case, the antenna device 10B can more reliably transmit electromagnetic waves in each of multiple directions (up to 8 directions) around the pillar 70.

In this case, the antenna device 10B can individually drive each of the 64 antenna elements 5 as required, that is, the antenna device 10B can radiate electromagnetic waves in only one or more particular directions. The antenna device 10B can radiate electromagnetic waves in multiple particular directions simultaneously or with a time difference. Further, the antenna device 10B can transmit multiple different kinds of signals to multiple particular directions simultaneously or with a time difference. For example, the antenna device 10B can be used for multiple-input and multiple-output (MIMO), beamforming, and the like.

(Cross-Sectional Configuration of Antenna Device 10B)

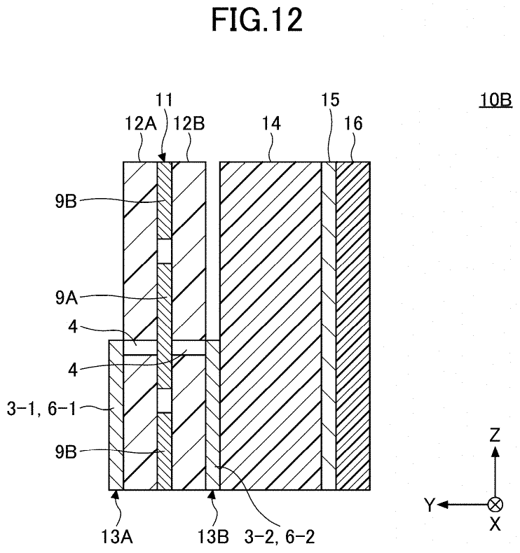

FIG. 12 is a drawing illustrating a cross-sectional configuration of the antenna device 10B according to the second modified embodiment. As illustrated in FIG. 12, the antenna device 10B according to the second modified embodiment includes a first wiring layer 13A, a first flexible substrate 12A, a conductor layer 11, a second flexible substrate 12B, a second wiring layer 13B, a dielectric 14, a reflector plate 15, and a flexible substrate 16, which are arranged from the front surface side (the positive side of the Y axis). In the antenna device 10B, the reflector plate 15 may be provided at least on the rear side (the negative side of the Y axis) with respect to the dielectric 14, and for example, the reflector plate 15 may be formed on the rear surface of the dielectric 14 (the surface on the negative side of the Y axis). In this case, the antenna device 10B does not have to have the flexible substrate 16.

That is, the antenna device 10B according to the second modified embodiment is provided with two flexible substrates 12A, 12B stacked on each other. In the antenna device 10B, the conductor layer 11 is provided between the two flexible substrates 12A, 12B. Furthermore, in the antenna device 10B, the first wiring layer 13A is provided on the front surface of the first flexible substrate 12A, and the second wiring layer 13B is provided on the rear surface of the second flexible substrate 12B.

In the antenna device 10B according to the second modified embodiment, the first wiring layer 13A is provided with the feeding lines 3-1, 6-1 illustrated in FIG. 11. The feeding lines 3-1, 6-1 are connected to the ground plate 9A provided in the conductor layer 11 through the via 4 penetrating the first flexible substrate 12A.

Furthermore, in the antenna device 10B according to the second modified embodiment, the second wiring layer 13B is provided with the feeding lines 3-2, 6-2 illustrated in FIG. 11. The feeding lines 3-2, 6-2 are connected to the ground plate 9A provided in the conductor layer 11 through the via 4 penetrating the second flexible substrate 12B.

As described above, the antenna device 10B according to the second modified embodiment includes the first wiring layer 13A and the second wiring layer 13B, so that the multiple feeding lines can be distributed to the first wiring layer 13A and the second wiring layer 13B. Thus, the antenna device 10B according to the second modified embodiment can reduce the number of wirings in each of the wiring layers 13A and 13B, and therefore, the degree of flexibility of wirings in the wiring layers 13A and 13B can be increased.

(Third Modified Embodiment of Antenna Device 10)

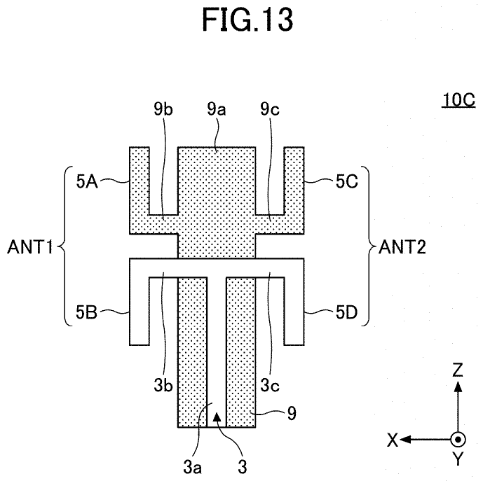

Next, a third modified embodiment of the antenna device 10 according to the embodiment is explained. FIG. 13 is a plan view illustrating an antenna device 10C according to the third modified embodiment. The antenna device 10C illustrated in FIG. 13 includes a dipole antenna ANT1, a dipole antenna ANT2, a feeding line 3, and a ground plate 9.

In the antenna device 10C, the ground plate 9 includes a base portion 9a having a vertically long rectangular shape, a branch portion 9b branching to the left side from the left edge portion of the base portion 9a, and a branch portion 9c branching to the right side from the right edge portion of the base portion 9a.

The feeding line 3 is provided in a layer closer to the front surface than is the ground plate 9, and is provided on the ground plate 9. The feeding line 3 includes: a straight line portion 3a extending linearly upward from the lower edge portion of the antenna device 10C at the central portion of the antenna device 10C in the horizontal direction (X axis direction); a branch portion 3b branching to the left side from the upper end portion of the straight line portion 3a; and a branch portion 3c branching to the right side from the upper end portion of the straight line portion 3a.

The dipole antenna ANT1 includes, on the left side of the ground plate 9, an antenna element 5A extending linearly upward, and an antenna element 5B extending linearly downward. The lower end portion of the antenna element 5A is connected to the left end portion of the branch portion 9b of the ground plate 9. The upper end portion of the antenna element 5B is connected to the left end portion of the branch portion 3b of the feeding line 3.

The dipole antenna ANT2 includes, on the right side of the ground plate 9, an antenna element 5C extending linearly upward, and an antenna element 5D extending linearly downward. The lower end portion of the antenna element 5C is connected to the right end portion of the branch portion 9c of the ground plate 9. The upper end portion of the antenna element 5D is connected to the right end portion of the branch portion 3c of the feeding line 3.

In the antenna device 10C, the ground plate 9, the antenna element 5A, and the antenna element 5C are formed on the rear surface of the flexible substrate 12 (see FIG. 12). Furthermore, in the antenna device 10C, the feeding line 3, the antenna element 5B, and the antenna element 5D are formed on the front surface of the flexible substrate 12.

When power is fed from the feeding line 3 to the antenna elements 5B, 5D, the antenna device 10C configured as described above can radiate vertically polarized waves in a predetermined frequency band from each of the dipole antennas ANT1, ANT2.

(Fourth Modified Embodiment of Antenna Device 10)

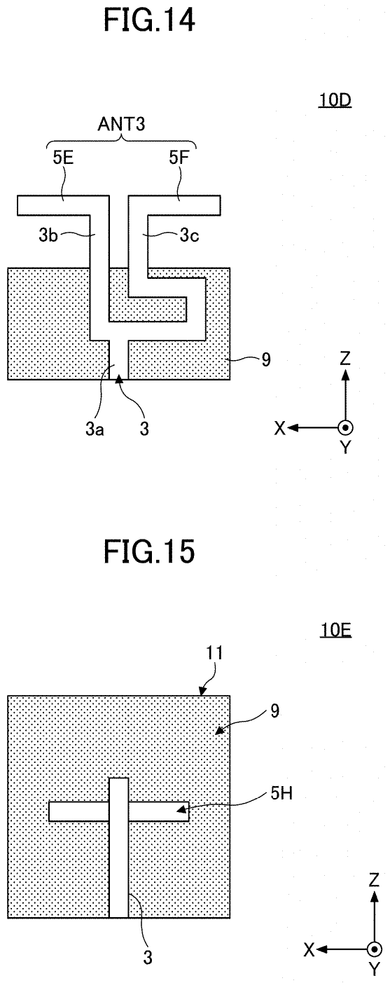

Next, a fourth modified embodiment of the antenna device 10 according to the embodiment is explained. FIG. 14 is a plan view illustrating an antenna device 10D according to the fourth modified embodiment. The antenna device 10D illustrated in FIG. 14 includes a dipole antenna ANT3, a feeding line 3, and a ground plate 9.

In the antenna device 10D, the ground plate 9 has a vertically long rectangular shape. The dipole antenna ANT3 and the feeding line 3 are provided in a layer closer to the front surface than is the ground plate 9.

The feeding line 3 includes: a straight line portion 3a extending linearly in the up-and-down direction; a branch portion 3b branching to the left side from the upper end portion of the straight line portion 3a; and a branch portion 3c branching to the right side from the upper end portion of the straight line portion 3a.

The dipole antenna ANT3 includes, on the front side with respect to the ground plate 9, an antenna element 5E extending linearly to the left side from the upper end portion of the branch portion 3b of the feeding line 3, and an antenna element 5F extending linearly to the right side from the upper end portion of the branch portion 3c of the feeding line 3.

In the antenna device 10D, the ground plate 9 is formed on the rear surface of the flexible substrate 12 (see FIG. 12). Furthermore, in the antenna device 10D, the feeding line 3, the antenna element 5E, and the antenna element 5F are formed on the front surface of the flexible substrate 12.

When power is fed from the feeding line 3 to the antenna elements 5E, 5F, the antenna device 10D configured as described above can radiate horizontally polarized waves in a predetermined frequency band from the dipole antenna ANT3.

(Fifth Modified Embodiment of Antenna Device 10)

Next, a fifth modified embodiment of the antenna device 10 according to the embodiment is explained. FIG. 15 is a plan view illustrating an antenna device 10E according to the fifth modified embodiment. The antenna device 10E illustrated in FIG. 15 includes an antenna element 5H and a feeding line 3.

In the example illustrated in FIG. 15, an antenna element 5H in a belt shape and in a slit shape that linearly extends in the horizontal direction (X axis direction) is provided in the central portion, in the vertical direction (Z axis direction), of the conductor layer 11 of the antenna device 10E. The antenna element 5H is what is termed as a slot antenna. The antenna element 5H is formed by cutting out a portion of the conductor layer 11. In the conductor layer 11 of the antenna device 10E, a portion on the outer side of the antenna element 5H functions as the ground plate 9.

The feeding line 3 linearly extends upward from the lower edge portion of the antenna device 10E at the central portion of the antenna device 10E in the horizontal direction (X axis direction). The feeding line 3 is open at a position of the ground plate 9 that is away by a distance of about ¼ λg (where λg is the electrical length of one wavelength in view of the effect of the dielectric constant of the flexible substrate 12) from the upper edge portion of the antenna element 5H, so that the feeding line 3 is electrically connected to the antenna element 5H in a non-contact manner by electromagnetic coupling. Therefore, the antenna element 5H can radiate vertically polarized waves.

When power is fed from the feeding line 3 to the ground plate 9, the antenna device 10E configured as described above can radiate vertically polarized waves in the predetermined frequency band from the antenna element 5H.

(Sixth Modified Embodiment of Antenna Device 10)

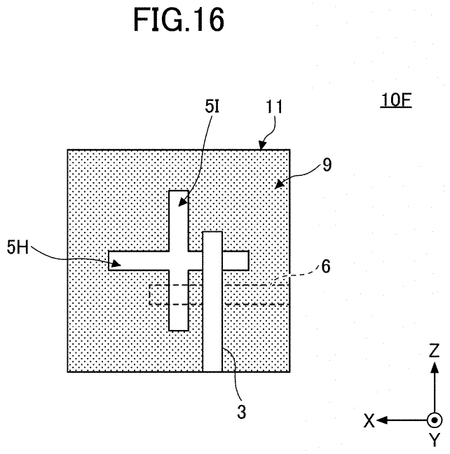

Next, a sixth modified embodiment of the antenna device 10 according to the embodiment. FIG. 16 is a plan view illustrating an antenna device according 10F to the sixth modified embodiment. The antenna device 10F illustrated in FIG. 16 further includes an antenna element 5I and a feeding line 6, as compared with the antenna device 10E illustrated in FIG. 15.

Similar to the antenna element 5H, the antenna element 5I is in a belt shape and in a slit shape. The antenna element 5I linearly extends in the vertical direction (Z axis direction) at the central portion in the horizontal direction (X axis direction) of the conductor layer 11 of the antenna device 10F. The antenna element 5I is orthogonal to the antenna element 5H.

In the antenna device 10F, the feeding line 3 is provided, on the front side of the conductor layer 11, to extend linearly upward from the lower edge portion of the antenna device 10F. The upper end portion of the feeding line 3 is open at a position of the ground plate 9 that is away by a distance of about ¼ λg (where λg is the electrical length of one wavelength in view of the effect of the dielectric constant of the flexible substrate 12) from the upper edge portion of the antenna element 5H, so that the feeding line 3 is electrically connected to the antenna element 5H in a non-contact manner by electromagnetic coupling. Therefore, the antenna element 5H can radiate vertically polarized waves.

In the antenna device 10F, the feeding line 6 is provided, on the rear side of the conductor layer 11, to extend linearly to the left side from the right edge portion of the antenna device 10F. The left end portion of the feeding line 6 is open at a position of the ground plate 9 that is away by a distance of about ¼ λg (where λg is the electrical length of one wavelength in view of the effect of the dielectric constant of the flexible substrate 12) from the left edge portion of the antenna element 5I, so that the feeding line 6 is electrically connected to the antenna element 5I in a non-contact manner by electromagnetic coupling. Therefore, the antenna element 5I can radiate horizontally polarized waves.

In the antenna device 10F, similar to the antenna device 10B illustrated in FIG. 12, the conductor layer 11 is provided between the two flexible substrates 12A, 12B. Furthermore, in the antenna device 10F, the feeding line 3 is provided on the front surface of the first flexible substrate 12A, and is electrically connected to the antenna element 5H in a non-contact manner by electromagnetic coupling. In the antenna device 10F, the feeding line 6 is provided on the rear surface of the second flexible substrate 12B, and is electrically connected to the antenna element 5I in a non-contact manner by electromagnetic coupling.

When power is fed from the feeding line 3 to the ground plate 9, the antenna device 10F configured as described above can radiate vertically polarized waves in the predetermined frequency band from the antenna element 5H.

Furthermore, when power is fed from the feeding line 6 to the ground plate 9, the antenna device 10F configured as described above can radiate horizontally polarized waves in the predetermined frequency band from the antenna element 5I.

Similar to the antenna device 10, each of the antenna devices 10B to 10F has the dielectric 14 having a certain thickness and the reflector plate 15. Therefore, any of the antenna devices 10B to 10F is installable along the curved surface, can achieve a wide bandwidth in a predetermined frequency band, and can enhance radiation in the front surface direction by reflecting the radiation of electromagnetic waves in the rear surface direction.

(Seventh Modified Embodiment of Antenna Device 10)

Next, a seventh modified embodiment of the antenna device 10 according to the embodiment is explained with reference to FIG. 25 to FIGS. 28A and 28B.

FIG. 25 is an external perspective view illustrating a flat state of an antenna device 10G according to the seventh modified embodiment. As illustrated in FIG. 25, the antenna device 10G according to the seventh modified embodiment has a horizontally long rectangular shape in a plan view as seen from the front surface side (the positive side in the Z axis). The antenna device 10G according to the seventh modified embodiment includes four antenna elements 5 arranged side by side of the X axis direction in the conductor layer 11. Each of the antenna elements 5 is the same as the antenna element 5 illustrated in FIGS. 1 and 2, that is, has a belt shape and a square shape. Similarly to the antenna element 5 illustrated in FIGS. 1 and 2, the ground plate 9A on the inner side of the respective antenna elements 5 is connected to the signal processing circuit 20 via the feeding line 3 and the connection line 21. With respect to the features other than the above, the antenna device 10G according to the seventh modified embodiment is the same as that of the antenna device 10 illustrated in FIGS. 1 and 2. In the antenna device 10G according to the seventh modified embodiment, the arrangement interval of two adjacent antenna elements is 0.5 λo. In the antenna device 10G according to the seventh modified embodiment, the thickness of the dielectric 14 is “0.1875*λo” and the dielectric constant of the dielectric 14 is “2”. As illustrated in FIG. 25, the antenna device 10G according to the seventh modified embodiment can be used in a flat state parallel to the XY plane.

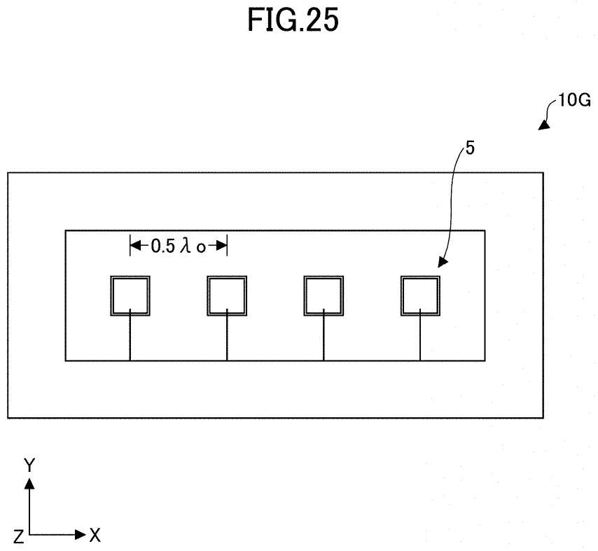

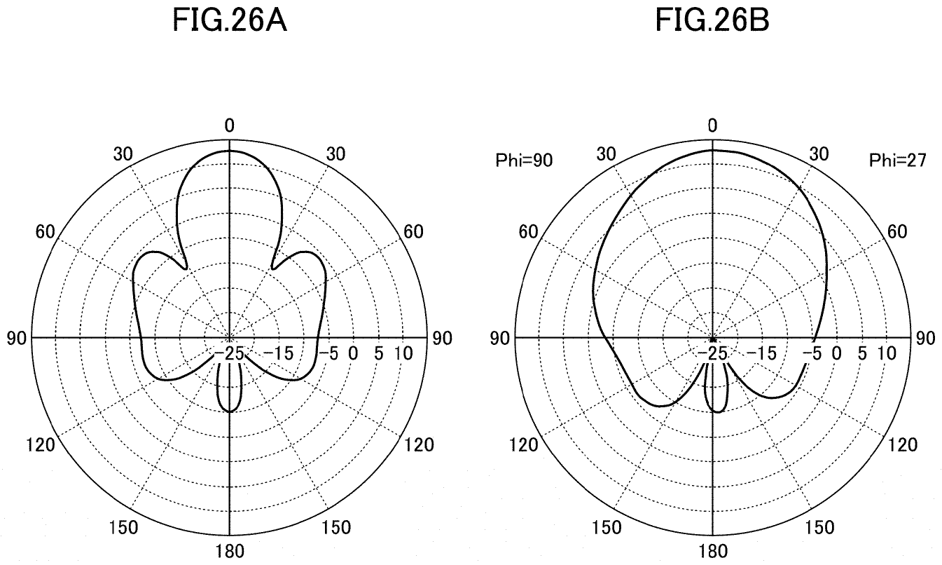

FIGS. 26A and 26B are drawings illustrating a directivity of the antenna device 10G according to the seventh modified embodiment (a flat state illustrated in FIG. 25). FIG. 26A illustrates the antenna characteristics in the ZX plane in a predetermined frequency band of the antenna device 10G according to the seventh modified embodiment. FIG. 26B illustrates the antenna characteristics in the YZ plane in the predetermined frequency band of the antenna device 10G according to the seventh modified embodiment. As illustrated in FIGS. 26A and 26B, it has been confirmed that the antenna device 10G according to the seventh modified embodiment can radiate electromagnetic waves with a sufficiently high gain (12.4 dBi) in a particular direction even when multiple antenna elements 5 are arrayed.

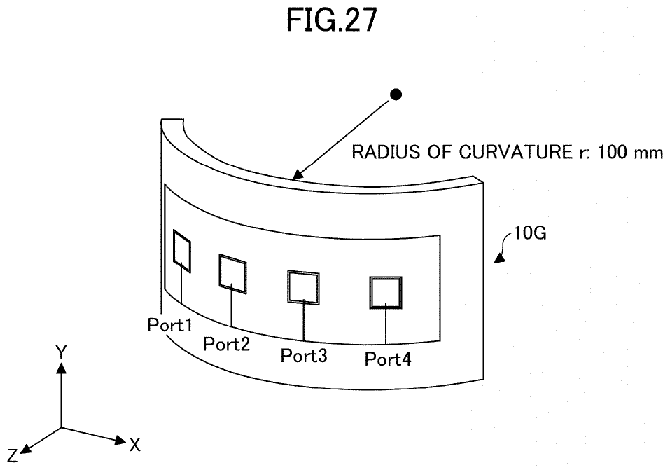

FIG. 27 is an external perspective view illustrating a bent state of the antenna device 10G according to the seventh modified embodiment. As illustrated in FIG. 27, the antenna device 10G according to the seventh modified embodiment can also be used in a bent state with respect to the XY plane. In the example illustrated in FIG. 27, the radius of curvature of the antenna device 10G is 100 mm.

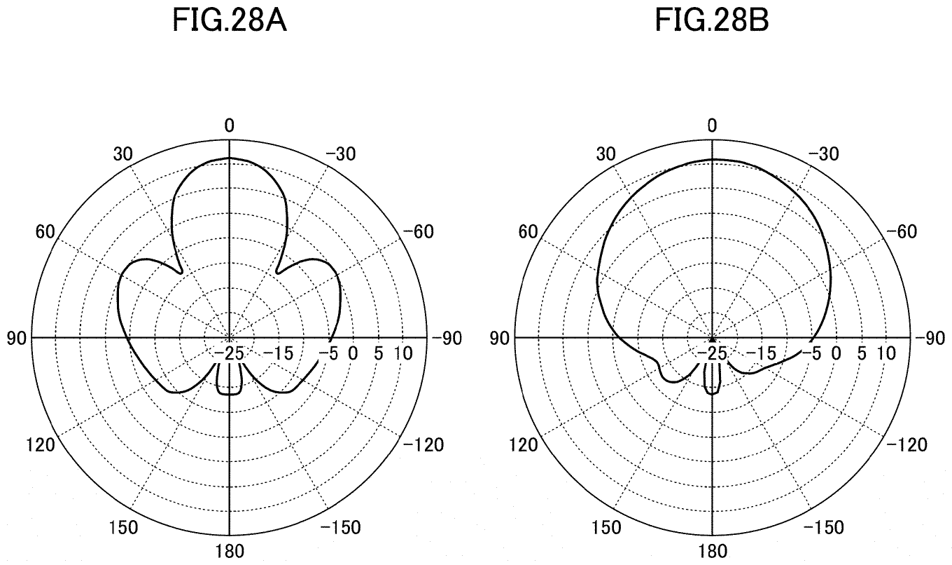

FIGS. 28A and 28B are drawings illustrating a directivity of the antenna device 10G according to the seventh modified embodiment (a bent state illustrated in FIG. 27). FIG. 28A illustrates the antenna characteristics in the ZX plane in a predetermined frequency band of the antenna device 10G according to the seventh modified embodiment. FIG. 28B illustrates the antenna characteristics in the YZ plane in the predetermined frequency band of the antenna device 10G according to the seventh modified embodiment. As illustrated in FIGS. 28A and 28B, it has been confirmed that, even when multiple antenna elements 5 are arrayed in a bent state, the antenna device 10G according to the seventh modified embodiment can radiate electromagnetic waves with a sufficiently high gain (11.1 dBi) in a particular direction, without appreciable change from the case of the flat state.

The configuration illustrated in the above embodiment shows an example of the contents of the present disclosure, and may be combined with other known techniques, or a part of the configuration may be omitted or changed without departing from the gist of the present disclosure.

What is claimed is:

1. An antenna device comprising:
a flexible substrate;
an antenna element provided on a front surface or a rear surface of the flexible substrate;
a feeding line provided on the front surface or the rear surface of the flexible substrate to feed power to the antenna element;
a dielectric in a plate shape stacked on a rear side of the flexible substrate, the dielectric having flexibility and being bendable; and
a reflector plate provided on a rear side of the dielectric.

2. The antenna device according to claim 1, wherein the antenna device is installable on an outer circumferential surface of an installation target object in a state where the antenna device is bent along the outer circumferential surface.

3. The antenna device according to claim 2, wherein the dielectric has such a thickness as to achieve a predetermined bandwidth in a predetermined frequency band.

4. The antenna device according to claim 1, further comprising:
a conductor layer formed on the front surface or the rear surface of the flexible substrate,
wherein the antenna element is in a slit shape that is formed by cutting out a portion of the conductor layer.

5. The antenna device according to claim 4, wherein the antenna element is in a rectangular shape in a plan view.

6. The antenna device according to claim 5, wherein a length of an edge of the antenna element is ¼ of a wavelength at a predetermined frequency.

7. The antenna device according to claim 5, wherein the feeding line is provided on a surface of the flexible substrate opposite to a surface on which the conductor layer is provided.

8. The antenna device according to claim 7, further comprising:
a via penetrating the flexible substrate,
wherein the feeding line is connected through the via to the conductor layer.

9. The antenna device according to claim 7, wherein the feeding line is electrically connected to the conductor layer in a non-contact manner by electromagnetic coupling.

10. The antenna device according to claim 8, further comprising:
a first feeding line for a vertically polarized wave configured to feed power to the antenna element; and
a second feeding line for a horizontally polarized wave configured to feed power to the antenna element.

11. The antenna device according to claim 1, further comprising:
a plurality of antenna elements provided on the front surface or the rear surface of the flexible substrate; and
a plurality of feeding lines provided for the plurality of antenna elements.

12. The antenna device according to claim 11, wherein the plurality of antenna elements are arranged, on the front surface or the rear surface of the flexible substrate, in a matrix form arranged in a vertical direction and a horizontal direction.
